(19) United States
(12) Patent Application Publication
(10) Pub. No.: US 2003/0034875 A1
(43) Pub. Date: Feb. 20, 2003

(54) Drive control unit using IPv6 and vehicle mounting the same

(75) Inventors: Norikazu Yamagishi, Yokohama-shi (JP); Mutsuharu Takesada, Yokohama-shi (JP); Nobuhiko Akinaga, Yokohama-shi (JP); Mina Imai, Yokohama-shi (JP)

Correspondence Address: Christopher J. Fildes, Fildes & Outland, P.C., Suite 2, 20916 Mack Avenue, Grosse Pointe Woods, MI, 48236, US

(73) Assignee: Hitachi Electronic Service Co., Ltd.

(21) Appl. No.: 10/205,684

(22) Filed: Jul. 25, 2002

(30) Foreign Application Priority Data
Aug. 16, 2001 (JP) 2001-246939

(51) Int. Cl. H04Q 1/00

(52) U.S. Cl. 340/5.6; 340/5.72; 340/825.52

(57) ABSTRACT

A drive control unit comprises an IPv6 input unit 14 that reads the IPv6 ID of a key 4 inserted to start said control unit and inputs said ID, an authorization control unit 15 for authorizing the input ID, a basic control unit 12 comprising a ROM storing the drive control function, an engine control unit 16 that ignites and controls the engine when the authorization is normal, a drive control unit 17 that controls the drive of said unit, an interior control unit 18 that controls the interior of the unit chamber, an exterior communication control unit 19 that controls the communication with the exterior, and a LAN control unit 13 that connects and controls each unit via a LAN.

### FIELD OF THE INVENTION

The present invention relates to a drive control unit using IPv6 and a vehicle mounting the same, and especially relates to a drive control unit and a vehicle capable of preventing unauthorized use.

### DESCRIPTION OF THE RELATED ART

Conventionally, a drive control unit or a vehicle mounting the drive control unit utilizes a key that is unique or specific to the unit so as to prevent unauthorized use thereof. It was possible according to the conventional unit to prevent unauthorized use to a certain extent, but since the conventional key can be duplicated easily, it was impossible to effectively prevent unauthorized use.

The present invention is aimed at solving the above-mentioned problems of the prior art, providing a drive control unit and a vehicle mounting the drive control unit, utilizing a key that is very difficult to duplicate, and thereby almost completely preventing unauthorized use of the unit and the vehicle.

### SUMMARY OF THE INVENTION

The present invention provides a drive control unit using IPv6, the drive control unit comprising an IPv6 input unit for reading the IPv6 ID of a key being inserted to start the drive control unit and inputting the ID, an authorization control unit for authorizing the ID being input, a basic control unit including a ROM storing a drive control function, an engine control unit for igniting and controlling the engine when authorization is normal, a drive control unit for controlling the drive of the control unit, an interior control unit for controlling the interior of the drive control unit chamber, an exterior communication control unit for controlling the communication with the exterior, and a LAN control unit for connecting and controlling each unit via a LAN.

The present invention further provides a drive control unit using IPv6, wherein the basic control unit comprises a function for reading a specific identification number (ID) from the ROM.

Moreover, the present invention provides a drive control unit using IPv6, wherein the IPv6 input unit comprises a function for reading the data stored in the key.

Further, the present invention provides a drive control unit using IPv6, wherein the authorization control unit comprises a function for comparing the data stored in the key with the data stored in the ROM.

The present invention provides a drive control unit using IPv6, wherein the authorization control unit comprises a function for notifying the basic control unit that authorization is completed when the compared data match.

The present invention provides a drive control unit using IPv6, wherein the drive control unit comprises a function for sequentially starting related control units after starting the basic control unit.

Further, the present invention provides a drive control unit using IPv6, wherein the drive control unit comprises a function for displaying that authorization is OK.

Moreover, the present invention provides a drive control unit using IPv6, wherein the drive control unit comprises a function for starting the engine.

Even further, the present invention provides a drive control unit using IPv6, wherein the drive control unit comprises a function for providing a warning when the authorization is disapproved.

The present invention provides a drive control unit using IPv6, wherein the warning is any one of or a combination of the following: video recording, outputting a warning signal, reporting to the exterior, cutting the power to the basic control unit, disabling drive, locking the steering wheel, locking the gear, reducing the tire pressure, turning off lights, locking the blinker, opacifying the windshield, controlling the brake, or disconnecting the fuse.

Moreover, the present invention provides a drive control unit using IPv6, wherein the drive control unit comprises a function for setting the warning method in advance.

Further, the present invention provides a drive control unit using IPv6, wherein the ROM storing the IPv6 data, which is the specific identification data of the unit, is equipped to the vehicle.

The present invention further provides a drive control unit using IPv6, wherein the key used for authorization is a key having a function for writing the IPv6 ID to the ROM.

The present invention provides a vehicle equipped with the above-mentioned drive control unit using IPv6.

### BRIEF DESCRIPTION OF THE DRAWINGS

FIG. 1 is an explanatory view showing the driver's seat of a vehicle, which is the drive control unit according to the present embodiment;

FIG. 2 is an explanatory view of the drive control unit according to the present embodiment;

FIG. 3 is an explanatory view of one example of the procedure for registering the IPv6 ID to the vehicle according to the drive control unit of the present embodiment;

FIG. 4 is an explanatory view showing one example of the procedure for registering the IPv6 ID to the key according to the drive control unit of the present embodiment;

FIG. 5 is an explanatory view showing one example of the setting when authorization is disapproved according to the drive control unit of the present embodiment;

FIG. 6 is an explanatory view showing one example of the procedure for processing the key input according to the drive control unit of the present embodiment; and

FIG. 7 is an explanatory view showing the procedure when authorization is disapproved according to the drive control unit of the present embodiment.

### DETAILED DESCRIPTION OF THE PREFERRED EMBODIMENT

The preferred embodiment of the present invention will now be explained.

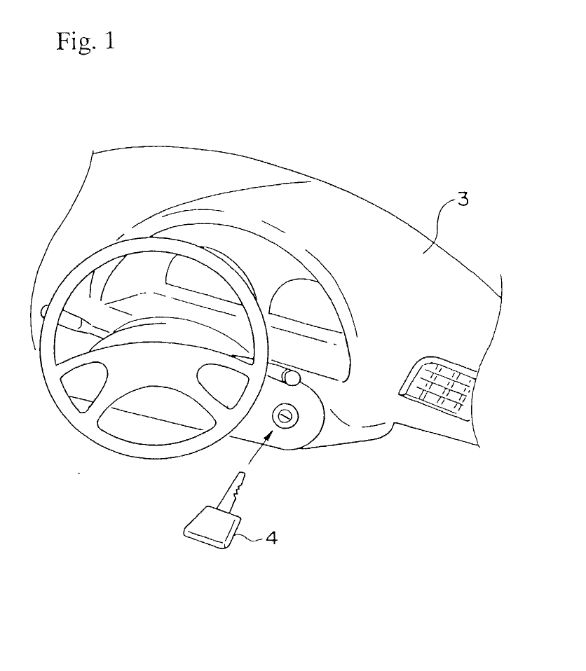

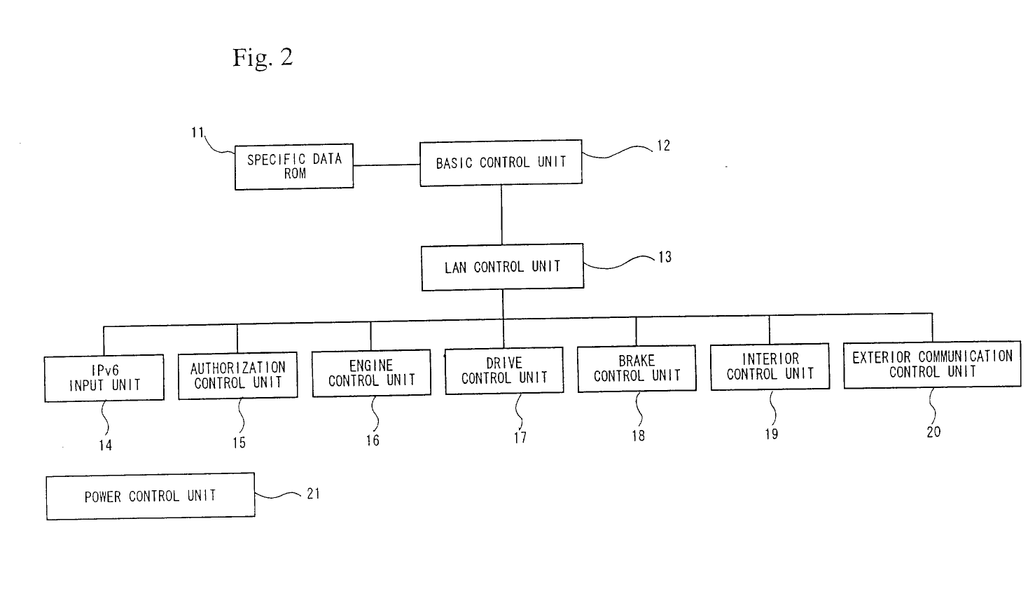

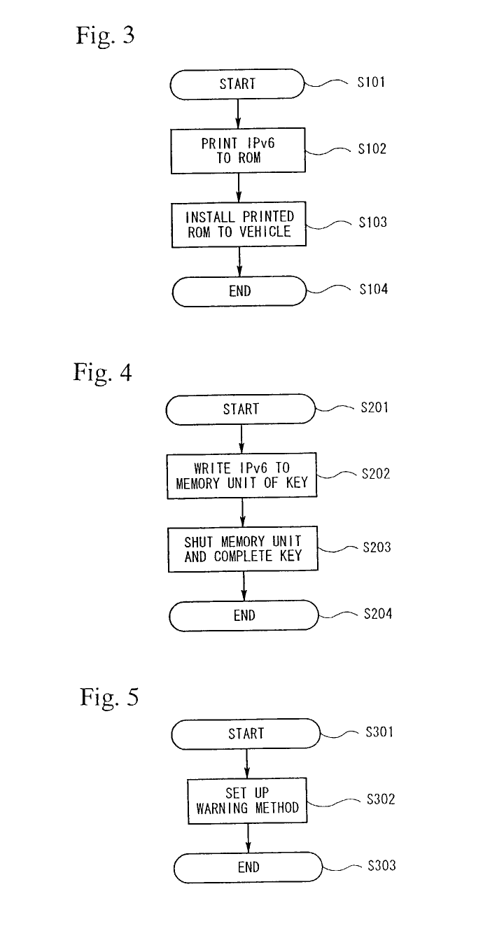

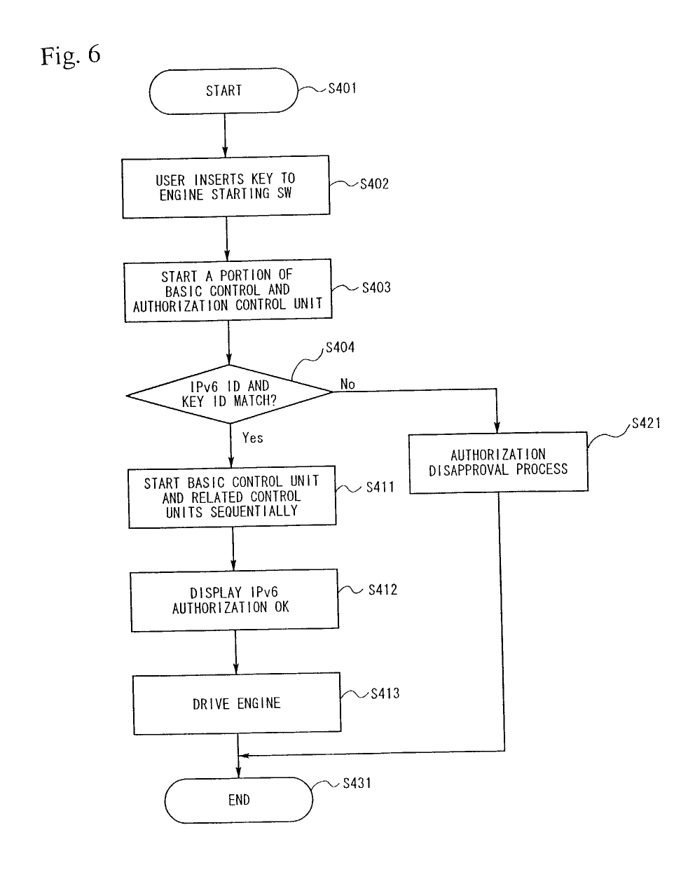

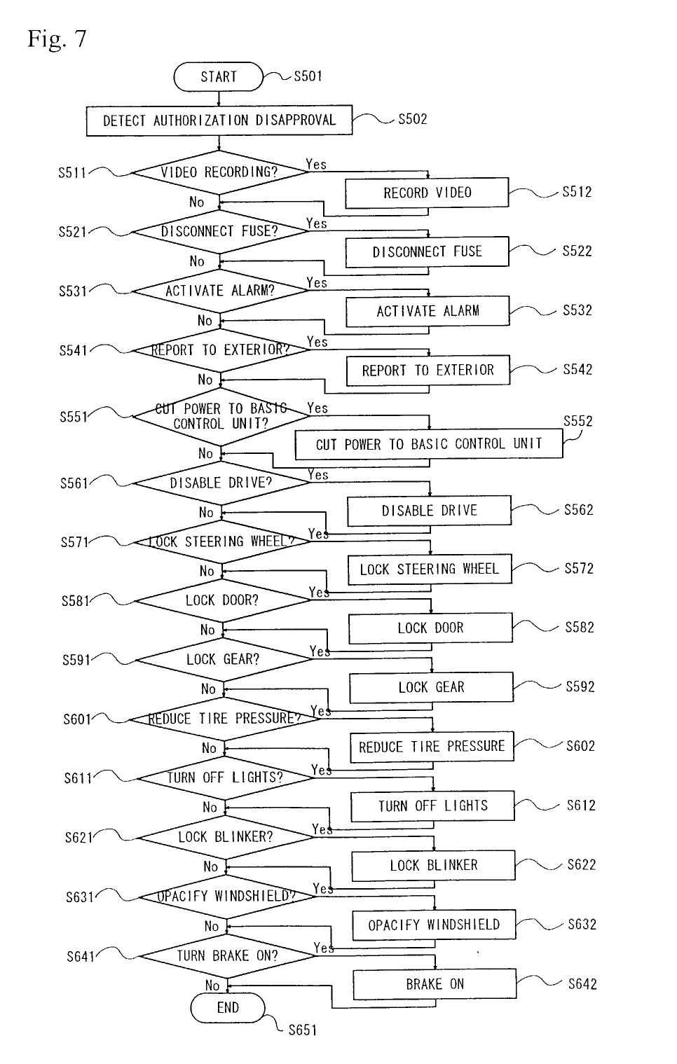

The embodiment of the drive control unit and the vehicle mounting the same according to the present invention will be explained with reference to FIGS. 1 to 7. FIG. 1 is an explanatory view showing the driver's seat of the vehicle, which is the drive control unit according to the present embodiment. FIG. 2 is an explanatory view showing the drive control unit of the embodiment. FIG. 3 is an explanatory view showing one example of the procedure for registering the IPv6 ID to the vehicle according to the drive control unit of the present embodiment. FIG. 4 is an explanatory view showing one example of the procedure for registering the IPv6 ID to the key according to the drive control unit of the present embodiment. FIG. 5 is an explanatory view showing one example of the setting when the authorization is disapproved according to the drive control unit of the present embodiment. FIG. 6 is an explanatory view showing one example of the procedure for processing the key input according to the drive control unit of the present embodiment. FIG. 7 is an explanatory view showing one example of the procedure when authorization is disapproved according to the drive control unit of the present embodiment.

The preferred embodiment will now be explained. The drive control unit of the present embodiment is equipped in a vehicle. The driver's seat of a vehicle 3 is shown in FIG. 1, and a key 4 is used to drive the vehicle. An IPv6 ID is recorded in the key 4 for authorization. As shown in FIG. 2, the drive control unit is equipped with a specific data ROM 11, a basic control unit 12, a LAN control unit 13, an IPv6 input unit 14, an authorization control unit 15, an engine control unit 16, a drive control unit 17, a brake control unit 18, an interior control unit 19, an exterior communication control unit 20, and a power control unit 21. The specific data ROM 11 is for recording the specific identification number (ID), such as the vehicle ID, the key ID etc., and is equipped to the vehicle body. IPv6 is used as the ID. IPv6 is a next-generation internet protocol that expands and improves the function of the present internet protocol, having an address length of 128 bits (approximately 3.8×10 to the 38th power), the specific IPv6 being the only number in the world, that corresponds to WADE, and can therefore be easily managed. The basic control unit 12 comprises a ROM that records the drive control function, and further comprises a function to read the specific identification ID number from the specific data ROM 11. The LAN control unit 13 connects and controls each unit via a LAN. The IPv6 input unit 14 reads the IPv6 ID of the key being inserted to the vehicle to start the unit, and inputs the ID. The authorization control unit 15 has a function to authorize the input ID by comparing the data from the key with the data recorded in the ROM. When the authorization is normal, the engine control unit 16 ignites the engine and controls the same. The drive control unit 17 controls the drive function of the unit. The brake control unit 18 controls the operation of the brake of the unit. The interior control unit 19 controls the various equipment inside the unit chamber. The exterior communication control unit 20 controls the communication with the exterior. The power control unit 21 is for controlling the power supply to the whole drive control unit.

The authorization control unit comprises a function for comparing the data recorded in the key with the data recorded in the ROM. If their contents match after the comparison, the authorization is notified as completed to the basic control unit, but when the authorization is disapproved, a warning is provided. When the authorization is completed, “authorization OK” display is provided, and the engine can be started. The warning provided when authorization is disapproved can be any one of, or a combination of, the following: video recording, activating an alarm, reporting to the exterior, cutting off the power to the basic control unit, disabling drive, locking the steering wheel, locking the gear, reducing the tire pressure, turning off the lights, locking the blinker, opacifying the windshield, controlling the brake, or disconnecting the fuse.

The operation of the drive control unit according to the present embodiment will now be explained. First, one example of the procedure for recording the IPv6 ID to the vehicle is explained with reference to FIG. 3.

S101: The procedure is started.

S102: The IPv6 is printed into the ROM.

S103: The recorded ROM is mounted to the vehicle.

S104: The procedure is ended.

According to such procedure, the IPv6 ID is recorded to the vehicle.

One example of the procedure for recording the IPv6 ID to the key according to the drive control unit of the present embodiment will be explained with reference to FIG. 4.

S201: The procedure is started.

S202: The IPv6 is recorded to the memory unit of the key.

S203: The recording unit is shut, and the key is ready for use.

S204: The procedure is ended.

According to such procedure, the IPv6 ID is recorded to the key.

FIG. 5 is referred to in explaining one example of the setting when the authorization is disapproved according to the drive control unit of the present embodiment.

S301: The procedure is started.

S302: The warning method is set up.

S303: The procedure is ended.

According to such procedure, the means of warning when the authorization is disapproved is set.

One example of the procedure for processing key input according to the drive control unit of the present embodiment will now be explained with reference to FIG. 6.

S401: The procedure is started.

S402: The user inserts the key to the engine starting switch SW.

S403: A portion of the basic control unit and the authentication control unit is started.

S404: It is judged whether the ID of IPv6 and the ID of the key match or not, and if they match the procedure advances to step S411, and if they do not match the procedure advances to step S421.

S411: The basic control unit is started, and the related control units are sequentially started.

S412: IPv6 authentication OK is displayed.

S413: The engine is started.

S421: The authentication disapproval process is performed.

S431: The procedure is ended.

As mentioned above, the procedure at the time of key input is performed.

One example of the procedure when authentication is disapproved according to the drive control unit of the present embodiment will now be explained with reference to FIG. 7.

S501: The procedure is started.

S502: The authentication disapproval is detected.

S511: Judgment is made on whether the setting designates video recording, and if video recording is designated the procedure advances to step S512, but if the recording is not designated the procedure advances to step S521.

S512: Video recording is performed, and the procedure advances to step S521.

S521: Judgment is made on whether the setting designates disconnecting a fuse, and if fuse disconnection is designated the procedure advances to step S522, but if fuse disconnection is not designated the procedure advances to step S531.

S522: The fuse is disconnected, and the procedure advances to step S531.

S531: Judgment is made on whether the setting designates an alarm, and if alarm is designated the procedure advances to step

S532, but if alarm is not designated the procedure advances to step S541.

S532: The alarm is activated, and the procedure advances to step S541.

S541: Judgment is made on whether the setting designates reporting to the exterior, and if reporting to the exterior is designated the procedure advances to step S542, and if reporting to the exterior is not designated the procedure advances to step S551.

S542: The report is output, and the procedure advances to step S551.

S551: Judgment is made on whether the setting designates cutting the power to the basic control unit, and if cutting of power is designated the procedure advances to step S552, but if not, the procedure advances to step S561.

S552: The power to the basic control unit is cut off, and the procedure advances to step S561.

S561: Judgment is made on whether the setting designates disabling drive, and if drive disable control is designated the procedure advances to step S562, but if not, the procedure advances to step S571.

S562: The drive is disabled, and the procedure advances to step S571.

S571: Judgment is made on whether the setting designates locking the steering wheel, and if locking of the steering wheel is designated the procedure advances to step S572, but if not, the procedure advances to step S581.

S572: The steering wheel is locked, and the procedure advances to step S581.

S581: Judgment is made on whether the setting designates locking the door, and if door lock is designated the procedure advances to step S582, but if not, the procedure advances to step S591.

S582: The door is locked, and the procedure advances to step S591.

S591: Judgment is made on whether the setting designates locking the gear, and if gear lock is designated the procedure advances to step S592, but if not, the procedure advances to step S601.

S592: The gear is locked, and the procedure advances to step S601.

S601: Judgment is made on whether the setting designates releasing the tire pressure, and if release of tire pressure is designated the procedure advances to step S602, but if not, the procedure advances to step S611.

S602: The tire pressure is released, and the procedure advances to step S611.

S611: Judgment is made on whether the setting designates turning off the lights, and if turning off of lights is designated the procedure advances to step S612, but if not, the procedure advances to step S621.

S612: The lights are turned off, and the procedure advances to step S621.

S621: Judgment is made on whether the setting designates locking the blinkers, and if locking of blinkers is designated the procedure advances to step S622, and if not, the procedure advances to step S631.

S622: The blinkers are locked, and the procedure advances to step S631.

S631: Judgment is made on whether the setting designates opacifying the windshield, and if opacifying is designated the procedure advances to step S632, but if not, the procedure advances to step S641.

S632: The windshield is opacified, and the procedure advances to step S641.

S641: Judgment is made on whether the setting designates turning on the brake, and if turning on of the brake is designated the procedure advances to step S642, but if not, the procedure advances to step S651.

S642: The brake is turned on, and the procedure advances to step S651.

S651: The procedure is terminated.

The procedure when authorization is disapproved is performed as explained above.

The present invention provides a drive control unit and a vehicle mounting the same, capable of almost completely preventing unauthorized use, by utilizing a key that is very difficult to duplicate.

What is claimed is:

1. A drive control unit using IPv6, said drive control unit comprising an IPv6 input unit for reading the IPv6 ID of a key being inserted so as to start said drive control unit and inputting said ID, an authorization control unit for authorizing said ID being input, a basic control unit including a ROM storing a drive control function, an engine control unit for igniting and controlling the engine when authorization is normal, a drive control unit for controlling the drive of said control unit, an interior control unit for controlling the interior of the drive control unit chamber, an exterior communication control unit for controlling the communication with the exterior, and a LAN control unit for connecting and controlling each unit via a LAN.

2. A drive control unit using IPv6 according to claim 1, wherein:
said basic control unit comprises a function for reading a specific identification number (ID) from said ROM.

3. A drive control unit using IPv6 according to claim 1, wherein:
said IPv6 input unit comprises a function for reading the data stored in the key.

4. A drive control unit using IPv6 according to claim 3, wherein:
said authorization control unit comprises a function for comparing the data stored in the key with the data stored in the ROM.

5. A drive control unit using IPv6 according to claim 4, wherein:
said authorization control unit comprises a function for notifying said basic control unit that authorization is completed when the compared data match.

6. A drive control unit using IPv6 according to claim 5, wherein:
said drive control unit comprises a function for sequentially starting related control units after starting the basic control unit.

7. A drive control unit using IPv6 according to any one of the preceding claims, wherein:
said drive control unit comprises a function for displaying that authorization is OK.

8. A drive control unit using IPv6 according to any one of claims 1-6, wherein:
said drive control unit comprises a function for starting the engine.

9. A drive control unit using IPv6 according to claim 4, wherein:
said drive control unit comprises a function for providing a warning when the authorization is disapproved.

10. A drive control unit using IPv6 according to claim 9, wherein said warning is any one of or a combination of the following:
video recording, outputting a warning signal, reporting to the exterior, cutting the power to the basic control unit, disabling drive, locking the steering wheel, locking the gear, reducing the tire pressure, turning off lights, locking the blinker, opacifying the windshield, controlling the brake, or disconnecting the fuse.

11. A drive control unit using IPv6 according to claim 10, wherein:
said drive control unit comprises a function for setting said warning method in advance.

12. A drive control unit using IPv6 according to claim 1, wherein:
said ROM storing the IPv6 data, which is the specific identification data of said unit, is equipped to the vehicle.

13. A drive control unit using IPv6 according to claim 1, wherein:
said key used for authorization is a key having a function for writing the IPv6 ID to the ROM.

14. A vehicle equipped with said drive control unit using IPv6 according to any one of the preceding claims.
